(19) United States
(12) Patent Application Publication
(10) Pub. No.: US 2007/0130158 A1
(43) Pub. Date: Jun. 7, 2007

(54) Downloadable content delivery management using a presence server

(76) Inventors: Maurice LaBiche, Cary, NC (US); Daniel P. Homiller, Cary, NC (US); L. Scott Bloebaum, Cary, NC (US)

Correspondence Address: MYERS BIGEL SIBLEY & SAJOVEC, P.A., P.O. BOX 37428, RALEIGH, NC, 27627, US

(21) Appl. No.: 11/295,366

(22) Filed: Dec. 6, 2005

(51) Int. Cl. G06F 17/30

(52) U.S. Cl. 707/10

(57) ABSTRACT

Methods of receiving availability data at a subscriber of a presence service include receiving from a presence server providing the presence service availability information associated with users associated with the subscriber of the presence service. Update information associated with a downloadable content record stored at a device remote from the presence server is received from the presence server. It is determined if the downloadable content record is new to the subscriber of the presence service based on comparing the received update information and current information for the downloadable content record maintained by the subscriber of the presence service. The downloadable content record may be, for example, a podcast. The presence server may received availability data associated with the downloadable content record and the presence server may be configured to provide the availability data to the subscriber of the presence service provided by the presence server in addition to the availability information associated with users associated with the subscriber of the presence service.

### BACKGROUND OF THE INVENTION

The present invention relates to personal electronic devices and, more particularly, to delivery of content to such devices.

The range of uses for computer processor based devices with communications capability continues to expand. One common usage is through the exchange of electronic mail (email) over the Internet based on the Internet Protocol, where source and destination devices are associated with identifying information, such as an Internet address or an alias for such an address. As such, a user sending an email message may identify a recipient based on an email address, which address may be evaluated to determine a destination device for routing the message to the intended recipient.

Another popular means of communication using computer processor based devices is instant messaging. Internet-based instant messaging applications have become popular for use in communication with selected other users without the delays associated with conventional email. In a typical instant messaging application, for example, AOL Instant Messenger, a user prepares a message for delivery to one or more other users, typically on a so-called “buddy list,” and transmits the message for delivery. The user receives messages from members of the buddy list in a similar manner. Users are generally identified by one or more “screen names.”

Instant messaging is generally based on the availability of a potential message recipient. Unlike email in which message delivery and response delays are customary, instant messaging is based on immediate response, and it is generally undesirable to send instant messages to a user who receives the messages hours or days later. Thus, applications capable of indicating status or presence of a user online have been developed, for example, applications, such as Instant Messaging and Presence (IM&P) services.

Users are typically connected to the Internet using computers, personal digital assistants (PDAs), web enabled mobile terminals or similar devices, and are allocated either a fixed Internet protocol (IP) address or a dynamic IP address, i.e., an IP address assigned by the Internet service provider (ISP). A first user of the IM&P services may register his presence with a presence server using the Internet by sending his username (screen name) and IP address to the presence server, thereby making his presence information available to other users, for example, subscribers. The first user may also be a subscriber and subscribe to the presence of second and third users. Thus, the presence server may inform the first user of the status or presence of the second and third users. For example, the second user may register his presence with the presence server, making his presence information available to all other users who are subscribed to the second user's presence. When the second user logs on, all of the users subscribed to the second user's presence, including the first user, may receive a notification that the second user has logged on. The presence of the first, second and third user's may be depicted on a display at the devices being used by the first, second and third users. For example, a “buddy list” may include a combination of screen names and icons, the presence of which on the display may indicate a user's presence online. Furthermore, the “buddy list” may also include an indication of the user's availability, for example, available, unavailable, busy, and the like.

Many standards for instant messaging and presence applications have recently been developed responsive to the increased use of such services. For example, the Wireless Village Standard and the Instant Messaging and Presence Standard (IMPS) have been developed to extend instant messaging and presence capabilities to portable electronic devices.

Podcasting is a technique for publishing content, typically audio or video programs, via the Internet. Podcasting typically uses a “feed,” such as an XML RSS (e.g., Really Simple Syndication) or Atom formatted file, to deliver an enclosed file. Independent producers, for example, can use podcasting to create self-published, syndicated “shows.” Listeners may subscribe to feeds using aggregator software, which periodically checks for and downloads new content automatically. Typical aggregators enable a user to copy podcasts to portable music players or other portable media players. Such feeds have also been used to deliver video content. A podcast is commonly viewed as including audio content, although the podcast concept may be viewed as encompassing audio and/or visual content transmission.

Mobile terminals with multimedia capabilities are also now available. For example, a mobile terminal may be provided with a radio tuner capability so as to receive amplitude modulation (AM) and/or frequency modulation (FM) broadcast radio channels by tuning to the station identifier for the radio station of a particular broadcast media source. Some mobile terminals also have the capability to play digital audio and/or video files, such as MP3 files and “podcasts,” which may be downloaded from Internet websites or from storage media.

### SUMMARY OF THE INVENTION

In some embodiments of the present invention, methods of receiving availability data at a subscriber of a presence service include receiving from a presence server providing the presence service availability information associated with users associated with the subscriber of the presence service. Update information associated with a downloadable content record stored at a device remote from the presence server is received from the presence server. It is determined if the downloadable content record is new to the subscriber of the presence service based on comparing the received update information and current information for the downloadable content record maintained by the subscriber of the presence service. The downloadable content record may be, for example, a podcast. The presence server may received availability data associated with the downloadable content record and the presence server may be configured to provide the availability data to the subscriber of the presence service provided by the presence server in addition to the availability information associated with users associated with the subscriber of the presence service.

In other embodiments, the current information is no information and determining if the downloadable content record is new includes determining that the downloadable content record is new to the subscriber of the presence service when the current information comprises no information. The current information may be an update time and/or version identification of a most recently downloaded copy of the downloadable content record and determining if the downloadable content record is new may include determining that the downloadable content record is new to the subscriber of the presence service when the update time and/or version identification of a most recently downloaded copy is earlier than the received last update time and/or version identification of the downloadable content record.

In further embodiments of the present invention, determining that the downloadable content record is new is followed by determining a download designation for the new downloadable content record and downloading the new downloadable content record based on the download designation. Determining a download designation may include displaying a new content icon on a list of an instant messaging client of the subscriber of the presence server and receiving a selection of the new content icon. Receiving the selection may be followed by removing the displayed new content icon.

In other embodiments of the present invention, an identification of the downloadable content record as a presence entity associated with the subscriber of the presence service is provided to the presence server. The downloadable content record may be a plurality of downloadable content records and identifications of each of the plurality of downloadable content records may be provided to the presence server. Displaying a new content icon may include displaying a new content icon with an indication of an associated one of the plurality of downloadable content records on the list for each of the new downloadable content records.

In yet further embodiments, determining the download designation for the new downloadable content record includes determining a previously determined criterion for the new downloadable content record. The previously determined criterion may include a designation of immediate or delayed downloading and downloading the new downloadable content may be followed by receiving a request to present the downloaded new downloadable content and presenting the downloaded new downloadable content responsive to the received request. Downloading the new downloadable content may be followed by generating an alert signal indicating availability of the downloaded new downloadable content.

In other embodiments of the present invention, the previously determined criterion is based on an associated type of the downloadable content record. The associated type may be time sensitive and the previously determined criterion may include a designation of immediate downloading and downloading the new downloadable content may be followed by generating an alert signal indicating availability of the downloaded new downloadable content.

In further embodiments of the present invention, receiving from the presence server update information is preceded by subscribing to the presence service at the presence server so as to allow the subscriber of the presence service to receive the update information each time a status of the downloadable content record is updated. Receiving from the presence server update information may be preceded by polling the presence server for current availability data associated with the downloadable content record.

In some embodiments of the present invention, methods of providing availability data include receiving at a presence server availability data associated with a downloadable content record stored at a device remote from the presence server. The presence server is configured to provide the availability data to at least one subscriber of a presence service provided by the presence server in addition to availability information associated with users associated with the at least one subscriber of the presence service. The downloadable content record may be a podcast and the availability data may include update information.

In other embodiments of the present invention, the update information may be a last update time and/or a version identification of the downloadable content record and the method further includes determining if the downloadable content record is new to the at least one subscriber of the presence service based on comparing the received update information and current information for the downloadable content record associated with the at least one subscriber and notifying the at least one subscriber if the downloadable content record is new to the at least one subscriber of the presence service. The received availability data may be stored at the presence server and the stored availability data may be distributed to the at least one subscriber. An availability indicator associated with the downloadable content record may be configured to indicate a status of the downloadable content record on a display of the at least one subscriber. An availability data update associated with the downloadable content record may be received at the presence server and the availability data update may be distributed to the at least one subscriber responsive to receipt of the availability data update.

In yet further embodiments of the present invention, computer program products for providing availability data include a computer readable storage medium having computer readable program code embodied in said medium. The computer readable program code includes computer readable program code configured to receive at a presence server availability data associated with a downloadable content record stored at a first device remote from the presence server, the presence server being configured to provide the availability data to at least one subscriber of a presence service provided by the presence server in addition to availability data associated with users associated with the at least one subscriber of the presence service.

Communications devices and computer program products for receiving availability data at a subscriber of a presence service or providing availability data are also provided.

### BRIEF DESCRIPTION OF THE DRAWINGS

FIG. 1 is a schematic diagram of a mobile terminal according to some embodiments of the present invention and an exemplary base station transceiver.

FIG. 2 is an exemplary “buddy list” including icons for downloadable content records according to some embodiments of the present invention.

FIG. 3 is a block diagram illustrating systems according to some embodiments of the present invention.

FIG. 4 is a flowchart illustrating operations of devices according to some embodiments of the present invention.

FIG. 5 is a flowchart illustrating operations of devices according to further embodiments of the present invention.

FIG. 6 is a flowchart illustrating operations of presence servers according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “personal electronic device” includes any a number of different electronic devices that may be configured to obtain and present downloadable content, such as podcasts. Examples of such personal electronic devices include, but are not limited to, personal computers (e.g., desktop, laptop and notebook), personal digital assistants (PDAs), mobile terminals (e.g., cellular telephones and cellular-capable PDAs), and media player devices (e.g., ipod and other music players).

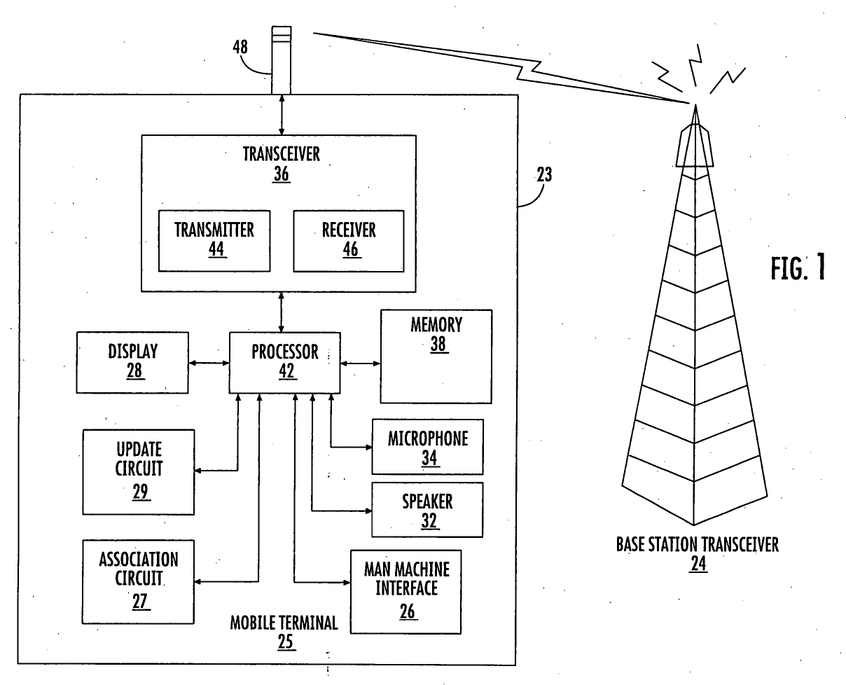

Embodiments of the present invention will now be described below with respect to FIGS. 1 through 6. Embodiments of the present invention provide methods, systems, devices and computer program products for providing and/or receiving availability data, i.e., presence information, associated with a downloadable content record, such as a podcast. The availability data may indicate a state of the downloadable content record, for example, available, unavailable, last updated, and the like. Personal electronic devices, for example, portable electronic devices, may be configured to receive availability data from a presence server. The presence server may be configured to receive the availability data from a device providing the downloadable content record and provide the availability data associated with the downloadable content record to users of personal electronic devices that either subscribe (subscribers) to a presence service provided by the presence server that allows access to availability data associated with the downloadable content records or request availability data from the presence service. Accordingly, some embodiments of the present invention may allow availability data associated with a downloadable content record to be shared by users of a presence service, in contrast to conventional presence services, which typically only support sharing of availability data associated with users.

As used herein, “availability data” or “presence information” refers to information related to the state of a downloadable content record stored at a provider device, such as a content server that may be communicatively coupled to personal electronic devices and the presence server, for example, using the Internet. For example, the availability data may indicate that the downloadable content record is unavailable, available, new, updated and the like. According to some embodiments of the present invention, subscribers of a presence service provided by a presence server may have access to this availability data as discussed further herein.

Operations related to accessing and providing availability information as described herein may be particularly beneficial where the downloadable content records are podcast. Podcasting has become very popular. The basic model for podcasting is that a client is subscribed to certain sources of multimedia content, which may be audio, video or the like. A client may be set up to check for new content and download on a regular schedule, such as once a day, or once a week, etc. While a client could be set up to check more frequently, such checking could unnecessarily increase network traffic. To utilize an alternative solution introducing alert messages being sent from content sites to subscribers would generally require the content sites to be aware of the subscribers, as contrasted with embodiments of the invention as described above where the content site need not be aware of the subscribers as the information provided by the content site is provided to a presence server, such as an instant messaging server.

Respective subscriber instant messaging client applications can maintain a list of subscriptions analogous to the buddy list of users for whom presence information is desired by the instant messaging client and these subscriptions may then correspond to presence entities which are known to and tracked by a presence server, which may reside on the Internet so as to communicate with both instant messaging clients and content sites. As such, the client may use standard instant messaging service protocols to monitor and track the availability and status of a given subscription site. In addition, in the same manner that an instant messaging client shows that a buddy (user) is present or not available, the presence server can provide information indicating whether the subscribed-to material is present at all, whether it is “new”, whether it was previously downloaded and the like.

The present invention is described below with reference to schematic and block diagrams of mobile terminals including circuits according to some embodiments of the present invention. Although embodiments of the present invention are discussed herein as being included as part of a mobile terminal, for example, the mobile terminal 25 of FIG. 1, embodiments of the present invention are not limited to this configuration. Embodiments of the present invention may be included in any wired or wireless device capable of communicating over the Internet or the like without departing from the scope of the present invention.

Embodiments of the present invention include mobile terminals or other personal electronic devices having the functionality of receiving availability data associated with a downloadable content record, such as a podcast. In particular, the exemplary receiving or subscribing mobile terminal 25 is illustrated in FIG. 1. FIG. 1 illustrates an exemplary wireless communication system in accordance with some embodiments of the present invention, which includes the mobile terminal 25 and a base station transceiver 24 of a wireless communications network. The mobile terminal 25 includes a portable housing 23 and may include a man machine interface 26, a display 28, a speaker 32, a microphone 34, a transceiver 36, and a memory 38, any of which may communicate with a processor (controller) 42. Furthermore, mobile terminals 25 according to embodiments of the present invention may further include an association circuit 27 and/or an update circuit 29 according to various embodiments of the present invention, which also communicate with the processor 42. The processor 42 can be any commercially available or custom microprocessor.

The transceiver 36 typically includes a transmitter circuit 44 and a receiver circuit 46, which respectively transmit outgoing radio frequency signals to the base station transceiver 24 and receive incoming radio frequency signals, such as voice signals and/or data signals, from the base station transceiver 24 via an antenna 48. The antenna 48 may be an embedded antenna, a retractable antenna or any antenna known to those having skill in the art without departing from the scope of the present invention. The radio frequency signals transmitted between the mobile terminal 25 and the base station transceiver 24 may comprise both traffic and control signals (e.g., paging signals/messages for incoming calls), which are used to establish and maintain communication with another party or destination. The processor 42 may support various functions of the mobile terminal 25, including Internet applications and communications, such as a browser module configured to communicate using the Wireless Application Protocol (WAP).

As used herein, the term “portable electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Digital Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver.

In some embodiments of the present invention, the base station transceiver 24 comprises the radio transceiver(s) that defines an individual cell in a cellular network and communicates with the mobile terminal 25 and other mobile terminals in the cell using a radio-link protocol. Although only a single base station transceiver 24 is shown, it will be understood that many base station transceivers may be connected through, for example, a mobile switching center and other devices to define a wireless communications network.

Although the present invention may be embodied in communication devices or systems, such as the mobile terminal 25, the present invention is not limited to such devices and/or systems. Instead, the present invention may be embodied in any apparatus that is capable of communicating over the Internet or the like according to embodiments of the present invention.

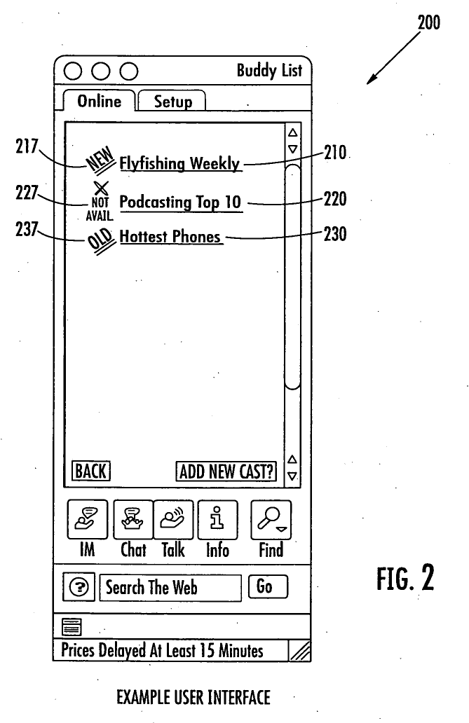

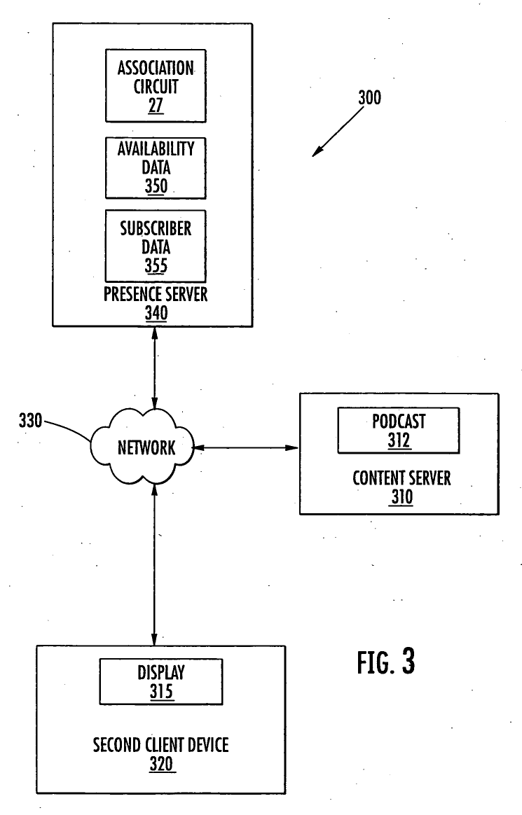

In some embodiments of the present invention, the association circuit 27 is configured to associate a downloadable content record 312, shown by way of example as a podcast in FIG. 3, with an availability indicator. The association circuit 27 in some embodiments further determines a state of the downloadable content record with respect to the mobile terminal 25 and sets the availability indicator based on the determined state. For example, the association circuit 27 may compare availability data indicating a last update time or version number for a copy of the downloadable content record posted at a content server and an update time or version number of a last copy of the downloadable content record that was downloaded by the mobile terminal 25. The availability indicator may be the same for each state across a plurality of different downloadable content records and may be displayed with an identification of the downloadable content record (e.g., “NEW,” “OLD,” “NOT AVAILABLE”). However, in some embodiments the availability indicator itself may both identify the downloadable content record (and/or its type, such as “NEWS”) and its state. Thus, as illustrated in FIG. 2, the availability indicator be provided with a text string, for example, “FLYFISHING WEEKLY” and/or an associated icon 217. The text string may be similar to a screen name 205 used to identify presence of a user.

It will be understood that the association of the downloadable content record 312 with an availability indicator and determination of its state may be performed at the receiving mobile terminal 25 and/or a presence server 340 (FIG. 3). As illustrated in FIGS. 1 and 3, the mobile terminal 25 and the presence server 340 may each include an association circuit 27, which may be configured to associate the downloadable content record with an availability indicator and/or determine its state. It will be understood that the association circuit 27 need not be present in both.

According to some embodiments of the present invention, the availability indicator may be configured to indicate availability data, i.e., presence information, associated with the downloadable content record 312. For example, the availability indicator may be presented on a display of a receiving device 25, remote from the providing content server 310 and the presence server 340 to indicate that a new/updated version of the downloadable content record 312 is available to be downloaded and viewed and/or heard. Furthermore, icons, for example, icons 217, 227 and 237 associated with text string availability indicators Fishing News 210, Podcasting Top 10 220 and Hottest Phones 230, respectively, may be used to indicate availability data with respect to the respective podcasts. For example, the icon 217 associated with Fishing News 210 indicates the podcast is new, the icon 227 associated with Podcasting Top 10 220 indicates the podcast is not available and the icon 237 associated with Hottest Phones 230 indicates the podcast is old. It will be understood that the indication of status may be performed using various techniques known to those having skill in the art without departing from the scope of the present invention.

Referring again to FIG. 1, the update circuit 29 of the receiving device 25 may be configured to update the availability indicator associated with the downloadable content record 312 responsive to received availability data. For example, the availability indicator may indicate that the downloadable content record 312 is available. When the downloadable content record 312 is no longer available, the availability indicator may be changed to indicate the unavailability of the downloadable content record. Alternatively, the availability indicator may be removed from the display of the receiving device 25, which may also indicate the unavailability of the downloadable content record. In some embodiments of the present invention, the receiving device 25 may receive a notification that the downloadable content record is unavailable and the update circuit 29 may be configured to change the availability indicator associated with the downloadable content record 312 to indicate that the downloadable content record 312 is no longer available.

It will be understood that although the association circuit 27 and the update circuit 29 are illustrated in FIG. 1 as being present in the mobile terminals 25, embodiments of the present invention are not limited to this configuration. For example, in some embodiments of the present invention, the association circuit 27 and the update circuit 29 may be included in a presence server configured to communicate with the mobile terminal 25 and other devices according to some embodiments of the present invention.

FIG. 3 illustrates an exemplary system 300 according to some embodiments of the present invention. As illustrated, the system 300 may a content server 310, personal electronic device 320, a network 330 and a presence server 340. It will be understood that the personal electronic device 320 and/or the presence server 340 may include association circuits 27 and/or update circuits 29 according to embodiments of the present invention as discussed with respect to FIG. 1. Furthermore, the downloadable content record 312 may be stored at the content server 310 and/or downloaded to the presence server 340 for downloading by the personal electronic device 320.

The personal electronic device 320 may be, for example, a laptop computer, a desktop computer, a personal digital assistant (PDA), a web capable mobile terminal or any device capable of communicating with the network 330. The content server 310 and personal electronic device 320 may communicate over the network 330, for example, the Internet, through a telephone line, a digital subscriber link (DSL), a broadband cable link, a wireless link or the like. The presence server 340 may also communicate over the network 330. Thus, the network 330 may convey data between the content server 310 and the personal electronic device 320 and the presence server 340.

A user of the personal electronic device 320 may subscribe to a presence service provided by the presence server 340. The presence server may store subscriber data 355 with respect to one or more subscribing devices. Thus, the user of the personal electronic device 320 may request availability data from the presence server 340 about the Flyfishing Weekly 210 (which may be stored by the content server 310 as a downloadable content record (e.g., podcast) 312. The presence server 340 may provide the requested availability data to the personal electronic device 320 by altering the availability indicator associated with the data file, Flyfishing Weekly 210, in this example, on a display 315 at the personal electronic device 310. As discussed above, the availability indicator may be altered using many techniques known to those having skill in the art without departing from the scope of the present invention. The availability indicator may be altered by the presence server 340 or the personal electronic device 320.

It will be understood that the personal electronic device 320 may receive continuous updates on the status of the downloadable content record(s) if the personal electronic device 320 specifically requests to receive such information, for example, if the personal electronic device 320 subscribes to the podcast, Flyfishing Weekly 210 in this example. If the personal electronic device 320 does not subscribe to the podcast, the personal electronic device 320 can still obtain availability data associated with a podcast, for example, querying or polling the presence server 340 for the availability data 350. In some embodiments of the present invention, the personal electronic device 320 may be authenticated by the presence server 340 before the availability data 350 is provided to the personal electronic device 320. The subscriber data 355 may be used to authenticate the requesting device.

It will be understood that embodiments of the present invention discussed with respect to FIG. 3 are provided for exemplary purposes only and embodiments of the present invention are not limited to this configuration. For example, although FIG. 3 only includes one content server 310 and one personal electronic device 320 and one presence server 340, more devices may be coupled to the network without departing from the scope of the present invention.

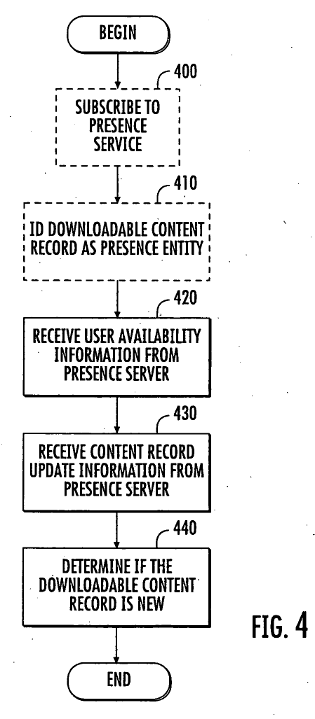

Referring now to FIG. 4, operations for receiving availability data at a subscriber of a presence service according to some embodiments of the present invention will now be described. For the embodiments illustrated in FIG. 4, operations may begin at block 400 by subscribing to the presence service so as to allow the subscriber of the presence service to receive update information each time the status of a downloadable content record or records is updated. The subscriber of the presence service may also provide an identification of one or more downloadable content records as presence entities associated with the subscriber to the presence server (block 410).

The subscriber device receives, from the presence server providing the presence service, availability information associated with users associated with the subscriber of the presence service (block 420). For example, such users may be identified based on a buddy list maintained by the subscriber of the presence service and the buddy list may be registered with the presence server. The subscriber receives from the presence server update information associated with a downloadable content record stored at a device remote from the presence server (block 430). For example, the downloadable content record may be a podcast, such as the podcast 312, and the device remote from the presence server may be the content server 310 as illustrated in FIG. 3. It is determined if the downloadable content record is new to the subscriber of the present service based on comparing the received update information and current information for the downloadable content record maintained by the subscriber of the presence service (block 430). As discussed previously, the determination of whether the downloadable content record is new may be performed by the subscriber of the presence service and/or at the presence server. As used herein, references to “the subscriber of the presence server” or “subscriber” will be understood to refer to a user subscribed to the service and/or a personal electronic device being used to carry out aspects of embodiments of the present invention.

In some embodiments of the present invention, operations at block 440 may include determining that the downloadable content record is new to the subscriber of the presence service when the current information comprises no information. In other words, a new podcast or the like of interest to the subscriber may become available that has not been previously downloaded by the subscriber. As such, there may be no current information because no previous version of the podcast has ever been downloaded by the subscriber. The current information may also be an update time and/or version identification of a most recently downloaded copy of a downloadable content record such as a podcast. The current update time and/or version may then be compared to update information and, if the most recently downloaded copy is earlier (in time or version number) than the received last update time and/or version identification of the downloadable content record, the downloadable content record may be identified as new to the subscriber.

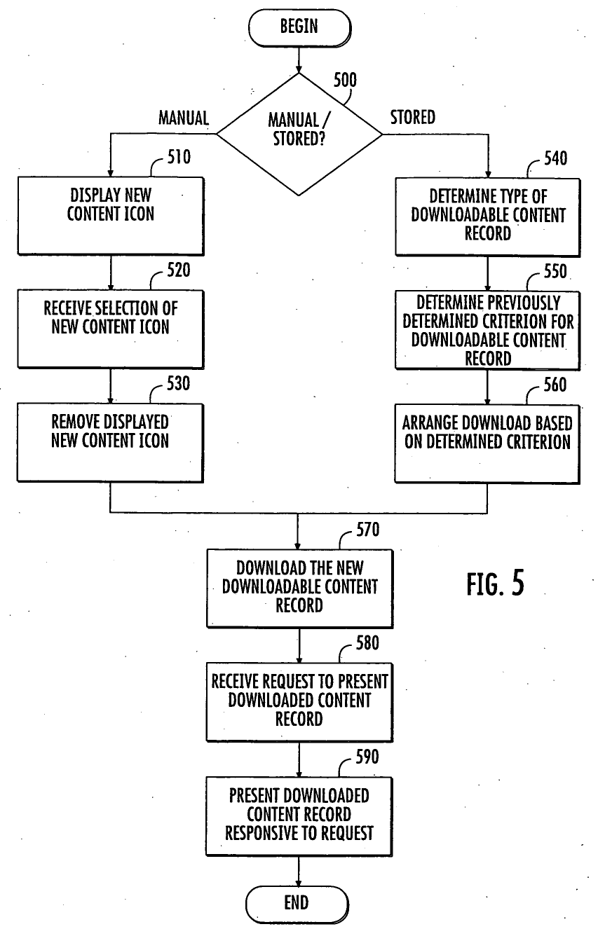

Referring to FIG. 5, operations subsequent to a determination that a downloadable content record is new according to some embodiments of the present invention will now be described. In various embodiments, subsequent operations may be linked to manual procedures requiring user input and/or based on stored information without requiring user intervention. If manual input is to be used (block 500), a new content icon may be displayed on a list of an instant messaging client of the subscriber of the presence server (block 510). Display of the new content icon at block 510 may include displaying the new content icon with an indication of an associated one of a plurality of downloadable content records on the list of the instant messaging client for any of the listed downloadable content records that are identified as new. A selection of the new content icon is received (block 520). After the selection indicating a request to download the updated/new downloadable content record is received, the displayed new content icon is removed (block 530). It will be understood that the particular manual input sequence and operations described with reference to blocks 510-530 is exemplary and some embodiments of the present invention receive input without, for example, utilizing display of an icon on a list of an instant messaging client of the subscriber.

In other embodiments of the present invention, stored information is utilized to determine a download designation for the new downloadable content record (block 500). A type associated with the downloadable content record is determined (block 540). For example, the downloadable content may be a time sensitive news type of content record. A previously determined criterion for the download designation for the new downloadable content record is determined (block 550). The previously determined criterion may include a designation of immediate or delayed downloading. The determined criterion may be identified based on the subscriber and/or the type of the new downloadable content. For example, for a particular subscriber, a financial news type downloadable content record may have an associated type indicating time sensitive and the previously determined criterion may include a designation of immediate downloading and an instruction that downloading of the new downloadable content be followed by generating an alert signal indicating availability of the downloaded new downloadable content. For example, where the receiving device of the subscriber is a mobile terminal, a ring or vibration may be generated in a pattern selected by the subscriber to indicate receipt of such new downloadable time sensitive content. A download of the new downloadable content is arranged based on the determined criterion (block 560).

The new downloadable content record is downloaded based on the determined criterion and/or user input providing a download designation for the downloadable content record (block 570). A request is received to present the downloaded content record (block 580). The downloaded new downloadable content record is then presented, for example, on a display of a personal electronic device that downloaded the content, responsive to the received request (block 590).

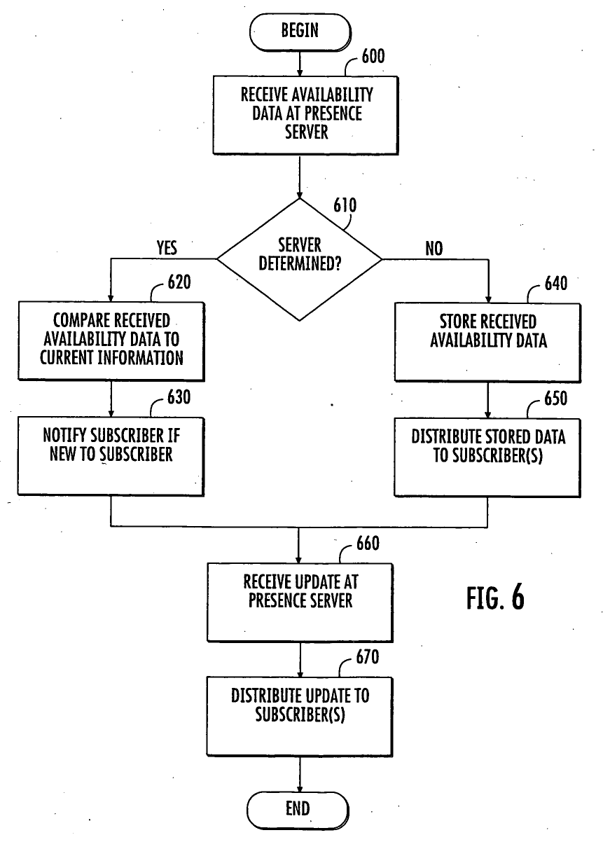

Methods of providing availability data according to some embodiments of the present invention will now be described with reference to the flowchart illustration of FIG. 6. As seen in the embodiments of FIG. 6, operations begin with receipt at a presence server of availability data associated with a downloadable content record or records stored at a device, such as a content server, remote from the presence server (block 600). The presence server may be configured to provide the availability data to one or more subscribers of a presence service provided by the presence server in addition to availability information associated with users associated with the subscriber(s) of the presence service. The received availability data may be updated information where the update may reflect a new/modified version of the downloadable content record and/or availability of a previously unavailable downloadable content record. The update information may be, for example, a last update time and/or a version identification of the downloadable content record.

As discussed above, in some embodiments of the present invention, the determination of whether the downloadable content record is new to a particular subscriber may be performed by the subscriber or the presence service (block 610). Where the presence server makes the determination, it is determined if the downloadable content record is new to a subscriber of the presence service based on comparing the received update information and current information for the downloadable content record associated with the subscriber (block 620). It will be understood that the comparison operations at block 620, when performed at the presence server, may be performed for a plurality of different downloadable content records for a plurality of different subscribers of the presence service. Respective subscribers are notified if the downloadable content record is new to the respective subscribers (block 630).

Where the presence server will not make the determination of whether the downloadable content record is new to a particular subscriber (block 610), the received availability data may be stored by the presence server (block 640). The stored availability data is then distributed to one or more subscribers, who may have registered and identified particular downloadable content records as being of interest to the subscribers (block 650). The provided and distributed availability data may be configured to indicate a status of the downloadable content record on a display of the receiving subscribers.

An availability data update associated with the downloadable content record may subsequently be received at the presence server (block 660). The availability data update may then be distributed to respective subscribers responsive to receipt of the availability data update (block 670). The distributed availability data update may be configured to indicate a change in status of the downloadable content record on a display of receiving subscribers. In some embodiments, distributing update operations at blocks 630, 650, and/or 670 may be preceded by polling of the presence server for current availability data associated with the downloadable content record by one or more subscribers.

For the embodiments illustrated in FIGS. 1 and 3, a client may reside on a mobile terminal. The subscribed-to content and a remote server and a presence server may also be provided to establish a basic system architecture for podcast content delivery management. Periodically or on power-up of the mobile terminal, the instant messaging client of the mobile terminal may interrogate the presence server for presence information relating to each of the instant messaging client's subscribed-to content sources. Depending upon the instant messaging client settings, when the presence server indicates that a given site has new information, the client may attach to the content server and download content, either immediately or at some future scheduled time. In either case, the content may be stored for later playback. When the content is downloaded, the client may locally re-set an associated status indicator for the content so that it would no longer read “new.” As such, the instant messaging client and presence server may maintain slightly different records regarding status of a downloadable content record as individual instant messaging clients may have more recently downloaded content than others. The client, having kept track of previous downloads, may then calculate and determine whether a particular content has been previously downloaded and, if not, the content may be marked by the client as new.

As described for particular embodiments above, the client may be configured so that certain changes in status will trigger audible, visual, and/or tactile alerts. For example, a user may have subscribed to a breaking news site and upon a change in status (based on information received from the presence server) to new, the client may automatically download the content, then immediately trigger an alert to let the user know that the new content is available. The alert could be an audible signal, such as a beep or ring tone, a visual signal, such as a blinking light, a vibrator, or any combination. Accordingly, some embodiments of the present invention provide for management, not only of delivery of such content, but of procedures related to notification and presentation to respective users of downloaded content, which procedures may be linked to user input and/or preconfigured settings (criterion) on the user's receiving device.

As discussed above, it will be understood that the association of the data file with the availability indicator may be performed by a receiving device and/or a presence server without departing from the scope of the present invention. For example, a user of a providing device may subscribe to a presence service provided by the presence server and the presence server may associate the data file with an availability indicator to be displayed on a display of the receiving device(s).

As will be appreciated by one of skill in the art, the present invention may be embodied as methods, systems, computer program products, and signal transmission media. Accordingly, the present invention may be embodied in hardware, software or combinations thereof. Furthermore, the present invention may take the form of a computer program product on a computer-usable storage medium having computer-usable program code embodied in the medium or as a signal embodied in a signal transmission medium. Applicable signal transmission media include, but at not limited to, wireline, wireless or optical transmission links as may be provided in a computer or telecommunications network. Applicable storage media include, but at not limited to, hard disks, CD-ROMs, optical storage devices and magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer (i.e., controller of the user's mobile terminal), partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of herein illustrate the architecture, functionality, and operations of some embodiments of the present invention. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of receiving availability data at a subscriber of a presence service, comprising:
receiving from a presence server providing the presence service availability information associated with users associated with the subscriber of the presence service;
receiving from the presence server update information associated with a downloadable content record stored at a device remote from the presence server; and
determining if the downloadable content record is new to the subscriber of the presence service based on comparing the received update information and current information for the downloadable content record maintained by the subscriber of the presence service.

2. The method of claim 1, wherein the downloadable content record comprises a podcast.

3. The method of claim 1, further comprising:
receiving at the presence server availability data associated with the downloadable content record, the presence server being configured to provide the availability data to the subscriber of the presence service provided by the presence server in addition to the availability information associated with users associated with the subscriber of the presence service.

4. The method of claim 1, wherein the current information comprises no information and wherein determining if the downloadable content record is new includes determining that the downloadable content record is new to the subscriber of the presence service when the current information comprises no information.

5. The method of claim 1, wherein the current information comprises an update time and/or version identification of a most recently downloaded copy of the downloadable content record and wherein determining if the downloadable content record is new includes determining that the downloadable content record is new to the subscriber of the presence service when the update time and/or version identification of a most recently downloaded copy is earlier than the received last update time and/or version identification of the downloadable content record.

6. The method of claim 5, wherein determining that the downloadable content record is new is followed by:
determining a download designation for the new downloadable content record; and
downloading the new downloadable content record based on the download designation.

7. The method of claim 6, wherein determining a download designation comprises:
displaying a new content icon on a list of an instant messaging client of the subscriber of the presence server; and
receiving a selection of the new content icon.

8. The method of claim 7, wherein receiving the selection is followed by removing the displayed new content icon.

9. The method of claim 7, further comprising providing an identification of the downloadable content record as a presence entity associated with the subscriber of the presence service to the presence server.

10. The method of claim 9, wherein the downloadable content record comprises a plurality of downloadable content records and wherein providing an identification comprises providing identifications of each of the plurality of downloadable content records to the presence server.

11. The method of claim 10, wherein displaying a new content icon comprises displaying a new content icon with an indication of an associated one of the plurality of downloadable content records on the list for each of the new downloadable content records.

12. The method of claim 6, wherein determining the download designation for the new downloadable content record comprises determining a previously determined criterion for the new downloadable content record.

13. The method of claim 12 wherein the previously determined criterion comprises a designation of immediate or delayed downloading and wherein downloading the new downloadable content is followed by receiving a request to present the downloaded new downloadable content and presenting the downloaded new downloadable content responsive to the received request.

14. The method of claim 13, wherein downloading the new downloadable content is followed by generating an alert signal indicating availability of the downloaded new downloadable content.

15. The method of claim 13, wherein the previously determined criterion is based on an associated type of the downloadable content record.

16. The method of claim 15, wherein the associated type comprises time sensitive and the previously determined criterion includes a designation of immediate downloading and wherein downloading the new downloadable content is followed by generating an alert signal indicating availability of the downloaded new downloadable content.

17. The method of claim 1, wherein receiving from the presence server update information is preceded by subscribing to the presence service at the presence server so as to allow the subscriber of the presence service to receive the update information each time a status of the downloadable content record is updated.

18. The method of claim 1, wherein receiving from the presence server update information is preceded by polling the presence server for current availability data associated with the downloadable content record.

19. A communications device configured to carry out the method of claim 1.

20. A computer program product for receiving availability data at a subscriber of a presence service, the computer program product comprising computer program code embodied in a computer readable medium, the computer program code comprising program code configured to carry out the method of claim 1.

21. A method of providing availability data, comprising:
receiving at a presence server availability data associated with a downloadable content record stored at a device remote from the presence server, the presence server being configured to provide the availability data to at least one subscriber of a presence service provided by the presence server in addition to availability information associated with users associated with the at least one subscriber of the presence service.

22. The method of claim 21, wherein the downloadable content record comprises a podcast and wherein the availability data includes update information.

23. The method of claim 22, wherein the update information comprises a last update time and/or a version identification of the downloadable content record and wherein the method further comprises the following:
determining if the downloadable content record is new to the at least one subscriber of the presence service based on comparing the received update information and current information for the downloadable content record associated with the at least one subscriber; and
notifying the at least one subscriber if the downloadable content record is new to the at least one subscriber of the presence service.

24. The method of claim 21, further comprising:
storing the received availability data at the presence server; and
distributing the stored availability data to the at least one subscriber, an availability indicator associated with the downloadable content record being configured to indicate a status of the downloadable content record on a display of the at least one subscriber.

25. The method of claim 24, further comprising:
receiving, at the presence server, an availability data update associated with the downloadable content record; and
distributing the availability data update to the at least one subscriber responsive to receipt of the availability data update.

26. A communications device configured to carry out the method of claim 22.

27. A computer program product for providing availability data, the computer program product comprising computer program code embodied in a computer readable medium, the computer program code comprising program code configured to carry out the method of claim 22.

28. A computer program product for providing availability data, the computer program product comprising:
a computer readable storage medium having computer readable program code embodied in said medium, said computer readable program code comprising:
computer readable program code configured to receive at a presence server availability data associated with a downloadable content record stored at a first device remote from the presence server, the presence server being configured to provide the availability data to at least one subscriber of a presence service provided by the presence server in addition to availability data associated with users associated with the at least one subscriber of the presence service.
